(19) United States
(12) Patent Application Publication
(10) Pub. No.: US 2014/0070922 A1
(43) Pub. Date: Mar. 13, 2014

(54) DOORBELL SYSTEM, APPARATUS, AND METHOD

(71) Applicant: Garry Davis, Columbus, IN (US)

(72) Inventor: Garry Davis, Columbus, IN (US)

(21) Appl. No.: 13/828,162

(22) Filed: Mar. 14, 2013

Related U.S. Application Data
(60) Provisional application No. 61/698,997, filed on Sep. 10, 2012.

(51) Int. Cl. G08B 3/10

(52) U.S. Cl. CPC G08B 3/1016
USPC 340/6.1

(57) ABSTRACT

Provided in various example embodiments is a system, apparatus, and method specially adapted to replace conventional doorbell systems in environments having access to wireless networks connected to the Internet, which provides wireless communication between the doorbell button unit and mobile devices without requiring additional or different power sources or wiring, aside from preexisting, conventional doorbell wiring.

### CROSS-REFERENCE TO RELATED APPLICATIONS

This application timely claims priority to and incorporates herein by reference co-pending U.S. provisional patent application Ser. No. 61/698,997 to Garry L. Davis, filed Sep. 10, 2012 and entitled Doorbell System.

### FEDERALLY SPONSORED RESEARCH OR DEVELOPMENT

None.

### TECHNICAL FIELD

The present invention relates generally to home automation and telecommunications, and more particularly, to a system, apparatus, and method for providing wireless communication between a doorbell and a mobile device.

### BACKGROUND

Various systems have been proposed for providing wireless communication between a doorbell and a mobile device. For example, the following U.S. patents and published patent applications describe other systems and are all incorporated herein by reference as if fully reproduced herein: U.S. Pat. No. 6,753,774 B2 issued Jun. 22, 2004 to Pan et al.; U.S. Pat. No. 7,015,943 B2 issued Mar. 21, 2006 to Chiang; U.S. Pat. No. 7,062,291 B2 issued Jun. 13, 2006 to Ryley, et al.; U.S. Pat. No. 7,085,361 B2 issued Aug. 1, 2006 to Thomas; U.S. Pat. No. 7,109,860 B2 issued Sep. 19, 2006 to Wang; U.S. Pat. No. 7,561,041 B2 issued Jul. 14, 2009 to Nguyen, et al.; U.S. Pat. No. 7,634,795 B2 issued Dec. 15, 2009 to Dureau; U.S. Pat. No. 7,683,924 B2 issued Mar. 23, 2010 to Oh, et al.; U.S. Pat. No. 7,746,223 B2 issued Jun. 29, 2010 to Howarter, et al.; U.S. Pat. No. 8,179,439 B2 issued May 15, 2012 to Resch, et al.; US 2004/0086093 A1 to Schranz published May 6, 2004; US 2008/0111684 A1 to Zinser published May 15, 2008; US 2008/0143517 A1 to Goffin published Jun. 19, 2008; and US 2010/0191608 A1 to Mikkelsen published Jul. 29, 2010. Inclusion of a reference in this list is not an admission that it qualifies as prior art.

While other systems providing wireless communication between a doorbell and a mobile device have been proposed, none have gained widespread adoption by the public, because they tend to be complicated and expensive, requiring special communication equipment, power source(s), and re-wiring of hidden areas, and are thus difficult to retrofit into an existing environment such as a residence with conventional doorbell wiring. A need exists for a simple, relatively inexpensive system that can provide all the functionality and features described in the above references, but which can be easily and quickly installed into typical environments such as existing structures without special skills or tools. The present invention fulfills these as well as other needs.

### SUMMARY

The present invention elegantly addresses all the above challenges and provides numerous additional benefits. In various example embodiments the solution discovered by the present inventor may comprise providing an apparatus, system, and method specially adapted to replace conventional doorbell systems in environments having access to wireless networks connected to the Internet, which provides wireless communication between the doorbell button unit and mobile devices without requiring additional or different power sources or wiring, aside from preexisting, conventional doorbell wiring.

Provided in certain example embodiments is a doorbell system, comprising: a doorbell button unit; and a doorbell chime unit; wherein the doorbell chime unit comprises a wireless receiver adapted to trigger a notification when the wireless receiver receives a signal from the doorbell chime unit indicating that the doorbell button unit has been activated, the doorbell chime unit further adapted to provide low voltage power to the doorbell button unit suitable for transmission through low voltage wiring, the chime unit further adapted to not disrupt the flow of electricity to the doorbell button unit during use; and wherein the doorbell button unit comprises a wireless transmitter adapted to send a signal to the wireless receiver of the doorbell chime unit when the doorbell button unit is activated, the doorbell button unit further adapted to communicate wirelessly with a network connected to the Internet when the doorbell button unit is activated, the doorbell button unit further adapted to be powered by the low voltage power provided by the doorbell chime unit, the doorbell button unit further adapted to not disrupt the flow of electricity to the wireless transmitter when the doorbell button unit is activated.

Example doorbell systems may be further adapted to cause at least one of an SMS, MMS, email message, or telephone call to be sent through a cellular telephone network to a wireless mobile device when the doorbell button unit is activated. The SMS, MMS, email message, or telephone call may comprise at least one of audio, video, text, or image content caused to be provided by the doorbell button unit. The SMS, MMS, or email message may comprises a link to a live streaming communication portal between the doorbell button unit and the wireless mobile device. The live streaming communication portal may be adapted to transmit to the wireless mobile device at least one of audio, video, text, or images originating from the doorbell button unit. The live streaming communication portal may be adapted to transmit to the doorbell button unit at least one of audio, video, text, or images originating from the wireless mobile device. The doorbell button unit may be further adapted to cause an electronic communication to be sent through the Internet to an electronic device in communication with the Internet when the doorbell button unit is activated. The electronic communication may comprise at least one of audio, video, text, or image content caused to be provided by the doorbell button unit. The electronic communication may comprise a link to a live streaming communication portal between the doorbell button unit and the electronic device in communication with the Internet, as discussed with regard to wireless mobile devices. The doorbell button unit may be adapted to be activated by sensing at least one of the following: force applied to a button connected with the doorbell button unit; movement of an object in the proximity of the doorbell button unit; the presence of something near the doorbell button unit; sound; biometric information; the passage of a predetermined amount of time; an activation signal sent wirelessly from a remote user to the doorbell button unit. The doorbell system may further comprise an infrared lighting system adapted for use in low-light conditions. The doorbell system may further comprise a camera having at least one of pan, tilt, or zoom functionality that is wirelessly controllable through the Internet by a remotely located user.

Also provided in various embodiments is a method comprising the steps of: providing an environment with wireless access to a network connected to the Internet; providing a structure in that environment having a conventional wired doorbell system, comprising low voltage wiring running from an existing doorbell chime unit to an existing doorbell button unit; replacing the existing doorbell chime unit with a replacement doorbell chime unit that chimes (the term “chime” when used herein means any type of doorbell sound) when it receives a predetermined wireless signal from a replacement doorbell button unit having a wireless transmitter, the replacement doorbell chime unit adapted to not disrupt the flow of electricity to the replacement doorbell button unit during use; and replacing the existing doorbell button unit with a replacement doorbell button unit by attaching the replacement doorbell button unit to the low voltage wires that powered the existing doorbell button unit, wherein the replacement doorbell button unit comprises a wireless transmitter that transmits the predetermined wireless signal to the replacement doorbell chime unit when the replacement doorbell button unit is activated, the replacement doorbell button unit adapted to not disrupt the flow of electricity to the wireless transmitter when the replacement doorbell button unit is activated, and the replacement doorbell button unit further adapted to communicate wirelessly with the network connected to the Internet when the replacement doorbell button unit is activated. The method may further comprise the steps of activating the replacement doorbell button unit, and receiving through the Internet a communication from the replacement doorbell button unit indicating that it has been activated.

Another example method may comprise the steps of: providing an environment with wireless access to a network connected to the Internet; providing a structure in that environment having conventional doorbell wiring, comprising low voltage wires running from a doorbell chime unit to a doorbell button unit; wherein the doorbell chime unit is adapted to chime when it receives a predetermined wireless signal from the doorbell button unit, which has a wireless transmitter, the doorbell chime unit adapted to not disrupt the flow of electricity to the doorbell button unit; wherein the doorbell button unit is attached to and powered by the low voltage wires and comprises a wireless transmitter that transmits the predetermined wireless signal to the doorbell chime unit when the doorbell button unit is activated, the doorbell button unit adapted to not disrupt the flow of electricity to the wireless transmitter when the doorbell button unit is activated, and the doorbell button unit further adapted to communicate wirelessly with the network connected to the Internet when the doorbell button unit is activated; activating the doorbell button unit; and causing the doorbell button unit to communicate wirelessly with the network connected to the Internet. This method may further comprise the step of: causing the doorbell button unit to communicate wirelessly with an end user located remotely from the doorbell button unit by causing the doorbell button unit to do at least one of the following: send an SMS message, MMS message, email, telephone call, or other electronic message to a wireless mobile device. The method may also comprise the step of: causing the doorbell button unit to communicate wirelessly with an end user located remotely from the doorbell button unit by establishing a live communication channel through the Internet between a first person located at the doorbell button unit and the remotely located end user.

Many other example system features and method steps are shown and described in the accompanying written description and figures. Additional aspects, alternatives and variations as would be apparent to persons of skill in the art are also disclosed herein and are specifically contemplated as included as part of the invention. The invention is set forth only in the claims as allowed by the patent office in this or related applications, and the descriptions herein of certain examples are not in any way to limit, define or otherwise establish the scope of legal protection.

### BRIEF DESCRIPTION OF THE DRAWINGS

The accompanying figures illustrate certain aspects of example embodiments of the invention.

FIG. 1 illustrates an example environment for implementation of example embodiments.

FIG. 2 illustrates example components and information flows in example embodiments.

FIG. 3A is a conceptual diagram illustrating the functionality of typical circuits used in conventional doorbell systems.

FIG. 3B is a conceptual diagram illustrating the functionality of circuits used in example embodiments.

FIG. 4 is a front view of an example doorbell button unit, illustrating example aspects thereof.

FIG. 5 illustrates an example circuit used in example embodiments of doorbell button units.

FIG. 6 illustrates an example circuit used in example embodiments of doorbell chime units.

FIG. 7 is a flow diagram illustrating example steps in an example embodiment.

FIG. 8 is a flow diagram illustrating example steps in an example embodiment.

### DETAILED DESCRIPTION OF EXAMPLE EMBODIMENTS

Reference is made herein to some specific examples of the present invention, including any best modes contemplated by the inventor for carrying out the invention. Some aspects of these example embodiments are illustrated in the accompanying figures. While the invention is described in conjunction with these specific embodiments, it will be understood that it is not intended to limit the invention to the described or illustrated embodiments. To the contrary, it is intended to cover alternatives, modifications, and equivalents as may be included within the spirit and scope of the invention as defined by the appended claims. Example embodiments of the invention will now be described.

Example Systems

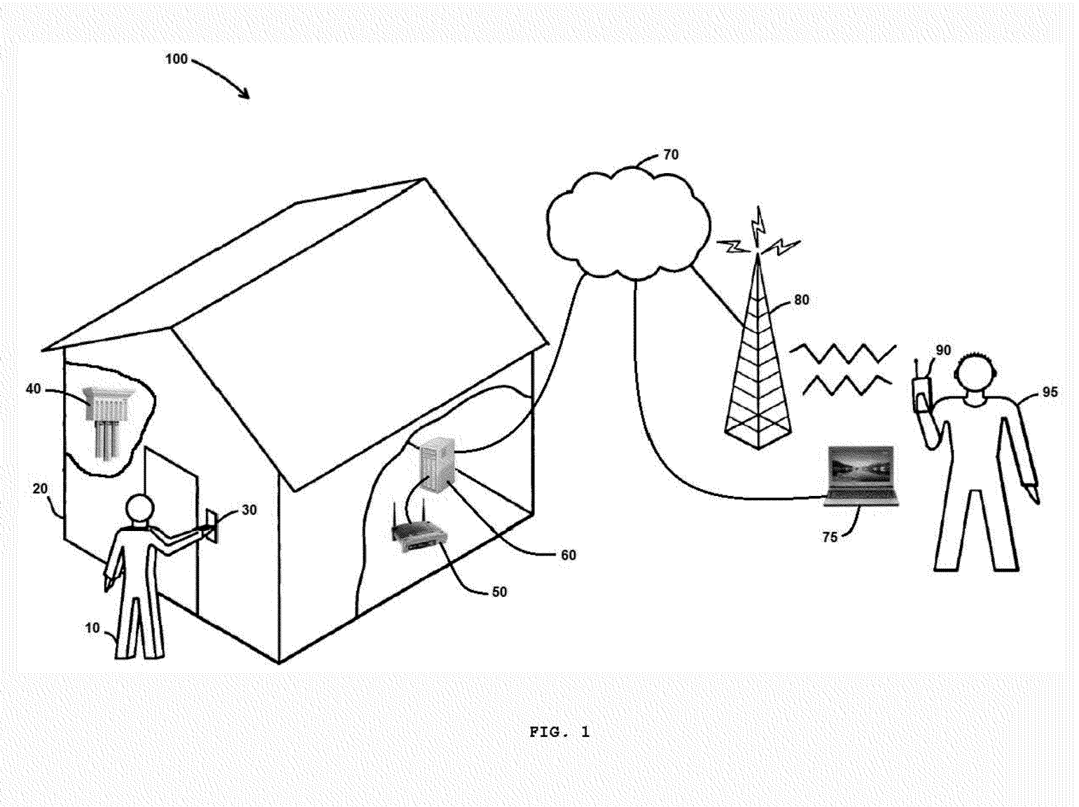

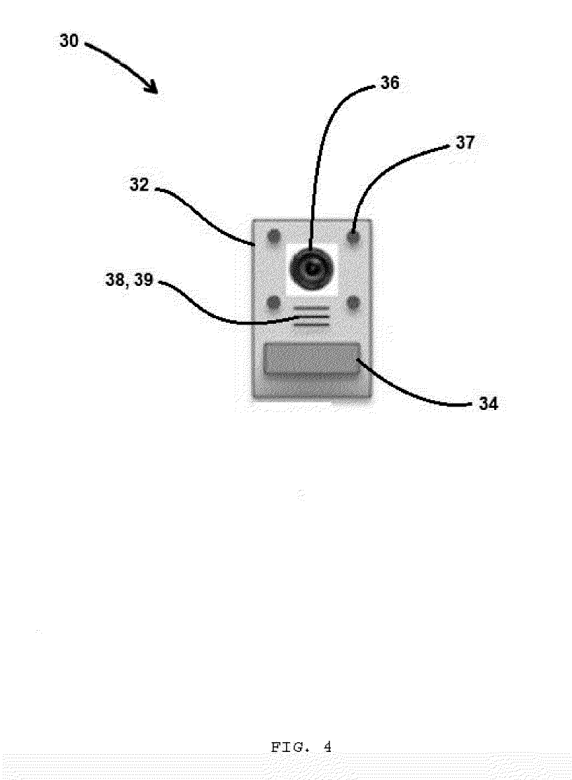

With reference to FIG. 1, provided in certain example embodiments is a doorbell system 100 for use in an environment having access to a wireless network 50, 60, connected to the Internet 70. The system 100 may be activated when a visitor or other first person 10 approaches a home, building, or other structure 20, and activates the doorbell button unit 30 (an example of which is shown in more detail in FIG. 4). The doorbell button unit 30 may be activated by pushing a doorbell button, or by triggering a motion sensor, a proximity sensor, a heat sensor, a sound sensor or voice recognition means, a biometric scanner, any combination of the above, or any other suitable electronic triggers (all possible triggers collectively represented as doorbell button 34).

Activating the doorbell button 34 typically does at least two things. First, doorbell structure 30 sends a wireless signal to the doorbell chime 40, causing it to chime or make any other sound or perceptible notification. The term doorbell chime 40 is understood herein to encompass any type of notification means, such as a bell, buzzer, chime, flashing lights, or any other suitable electronic response to the pushing of a doorbell button. Second, doorbell structure 30 causes a wireless communication to be transmitted to mobile devices 90 and/or remotely located computing devices 75, where it can be received by a system user or other second person 95. The doorbell structure 30 may accomplish this by transmitting a wireless signal to a wireless router 50 that is connected to the Internet with a modem or other device 60 providing a gateway to the Internet 70, such an Internet Service Provider (ISP) with a Simple Mail Transfer Protocol (SMTP) gateway. By establishing this connection with the Internet 70, the doorbell structure 30 may cause an email or other electronic communication to be sent to another device connected to the Internet, such as a remotely located computer 75 or any other IP enabled device. Also by establishing this connection with the Internet 70, the doorbell structure 30 may establish communication with a wireless telephone network 80, and send a message to a mobile phone or similar device 90, such as an SMS message (Short Message (or Messaging) Service, a system that enables cellular phone users to send and receive text messages), or an MMS message (Multimedia Messaging Service, a system that enables cellular phones to send and receive pictures and sound clips as well as text messages).

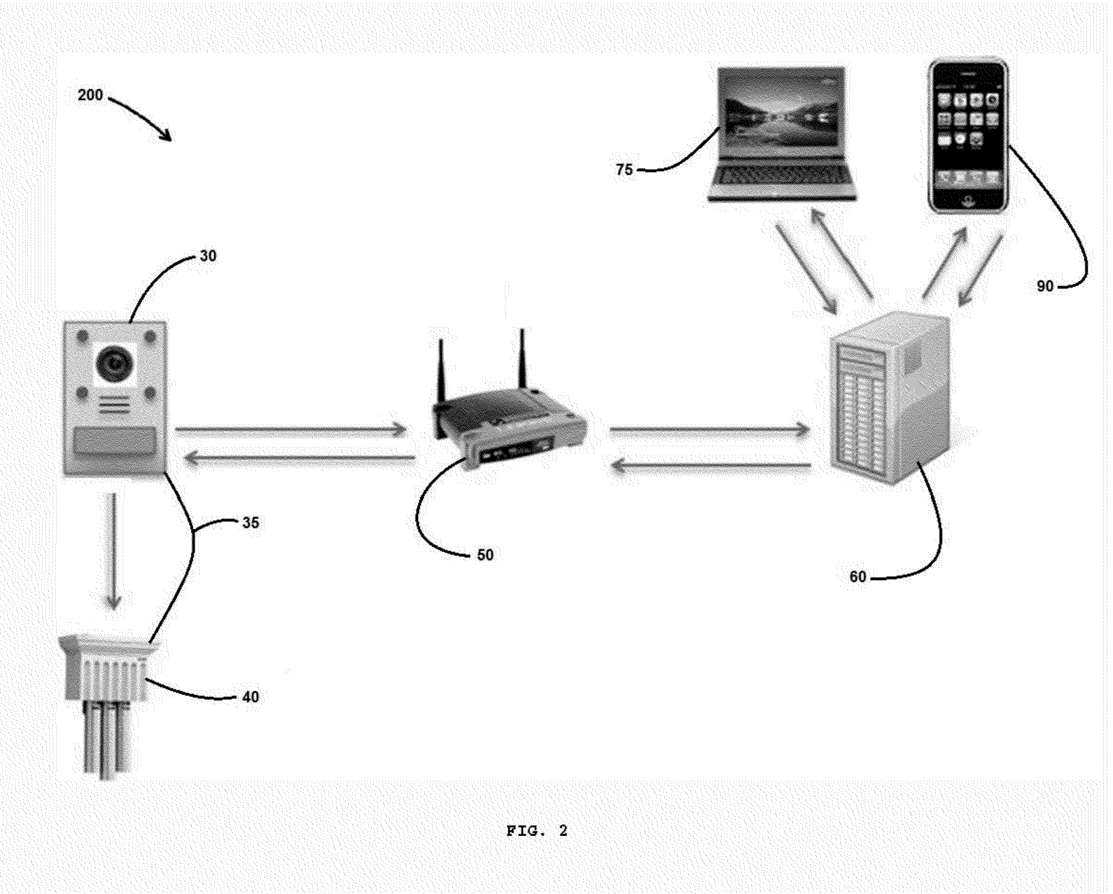

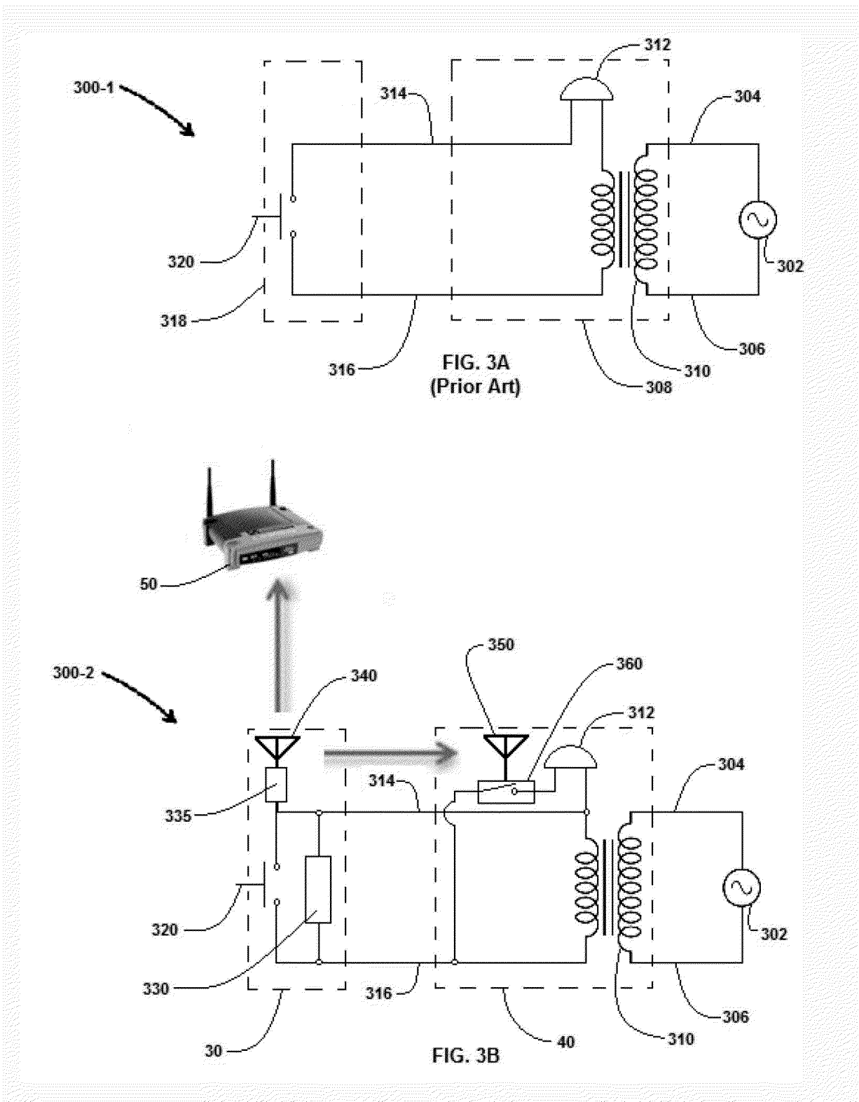

Example communication paths 200 are illustrated in FIG. 2. In various example embodiments one-way or two-way communications can be established between mobile devices 90 and/or remotely located computing devices 75 and doorbell structure 30, allowing first and second persons 10, 90 to communicate in real time while located remotely from each other, or allowing the user or second person 90 to observe or monitor the visitor or first person 10, either in real time or later. For instance, upon notification to the mobile phone 90, PC, Tablet, or other IP enabled device 75, a live audio and/or video connection can be established, for instance by the user 95 clicking on a link in the message that opens a browser at an IP address that is streaming the audio and/or video or otherwise providing a one-way or two-way communication channel. Alternatively, a recorded stream may be provided, which may comprise audio, video and/or still images. In addition to two-way communications, the system 100 may provide other functionality for the remote user 95, such as the ability to control any other devices that are connected to the Internet, such as lights, televisions, stereos, or the like at the location 20. For example, the remote user 95 may be able to control optional pan, tilt, and zoom (PTZ) features of a camera 36 associated with the doorbell structure 30. The doorbell button unit 30 may receive its power from the doorbell chime unit 40 via wiring 35, which may comprise conventional doorbell button wiring 314, 316 as discussed further below with respect to FIGS. 3A and 3B.

Features that may be provided with the hardware and software of the system 100 may include, but are not limited to, any or all of the following: activating the doorbell button 34 triggers doorbell chime 40 and automatically sending an SMS/MMS/email message to user 95; allowing user 95 to establish two-way audio between doorbell button unit 30 and mobile phone 90 or IP-enabled device 75; allowing user 95 to establish a live video connection with the doorbell camera 36; provide a screen (not shown) on doorbell button unit 30 to optionally display video of the remotely located user 95 (i.e., two-way video communication); the doorbell button unit 30 having low power consumption so that it can operate safely with conventional 18 AWG doorbell button wiring; and the radio frequency (RF) communications between the doorbell button unit 30 and the doorbell chime unit 40 having at least a 50 ft. operating range. Additionally, the system 100 may be adapted to support multiple doorbell button units 30 at a single location 20. For example, the doorbell chime unit 40 may be adapted to play a unique tone or melody for each doorbell button unit 30, and the text portions of the SMS, MMS, and email messages sent by each doorbell button unit 30 can be uniquely user defined (e.g., “Front Door” for a doorbell button unit 30 installed at the front door and “Back Door” for a doorbell button unit 30 installed at the back door). Where motion detection or other means are used to activate the doorbell button 34, sensitivity adjustment means may be provided in the system 100, including adjustments made remotely by a user 95 through the Internet 70. The doorbell button units 30 may detect ambient lighting levels and activate one or more infrared (IR) light emitting diodes (LEDs) 37 during low light conditions, where the camera 36 is adapted to detect reflected IR light, for instance with an IR cut-off (IR CUT) filter. The user 95 may have the ability to predetermine the lengths of video clips or number of frames to be sent with MMS/email messages. Conventional software is provided to configure the module for the camera 36 to communicate with the wireless router 50, for instance by being compliant with IEEE 802.11 b/g. The doorbell button unit 30 is preferably adapted to be weather resistant or weather proof. In various example embodiments the doorbell button unit 30 may be provided with the ability to record video and/or audio. In other embodiments, video and/or audio may be recorded on another networked device, or on the Internet 70. The user 95 may be provided with the ability to remotely schedule times of day and days of week when features of the system will be activated, such as video and/or audio recording. The remotely-located user 95 may be provided with the ability to record video and/or audio on-demand. The system 100 is preferably adapted to support multiple network protocols such as TCP/IP, HTTP, UDP, SMTP, UPNP, DDNS, DHCP, FTP, as well as standard security protocols, including WEP, WPA, and WPA2 encryption.

Example Apparatus

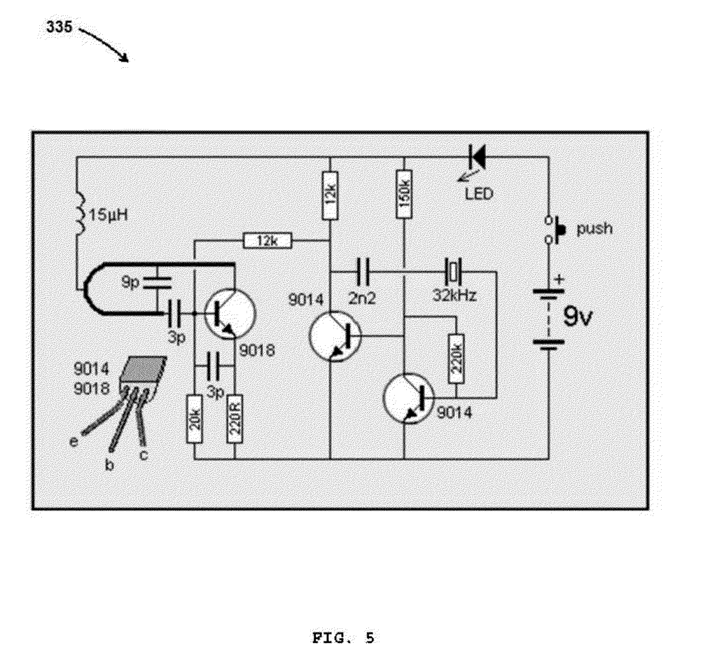

FIG. 4 depicts an example doorbell button unit 30, comprising a housing 32, a doorbell button 34 (which can comprise any suitable triggers means, such as a push-button, a motion sensor, a proximity sensor, a heat sensor, a sound sensor or voice recognition means, a biometric scanner, any combination of the above, or any other suitable electronic triggers), a camera 36 (which may include PTZ capability), an IR lighting system 37 for use in low-light conditions, a speaker 38, and a microphone 39. Various of these features may or may not be present in any particular embodiment, and other embodiments may have other or different features, such as a screen (not shown) for use with two-way video communications. FIG. 5 illustrates an example circuit used as part of an example embodiment of doorbell button unit 30. FIG. 3B also discloses, in general terms, circuitry that may be used to implement doorbell button unit 30 using existing conventional doorbell wiring 314, 316.

In one example embodiment, camera 36 comprises a 38×38 mm Megapixel IP WiFi Wireless Camera Board Module For IP, from Gold in Guangdong, China, model number GQ-IPC10-100 HZ75B, which comprises an IP WiFi Module integrated with a CMOS Camera Sensor, operates on 12V DC and draws 6 W of power, and is capable of providing the wireless video functionality described herein.

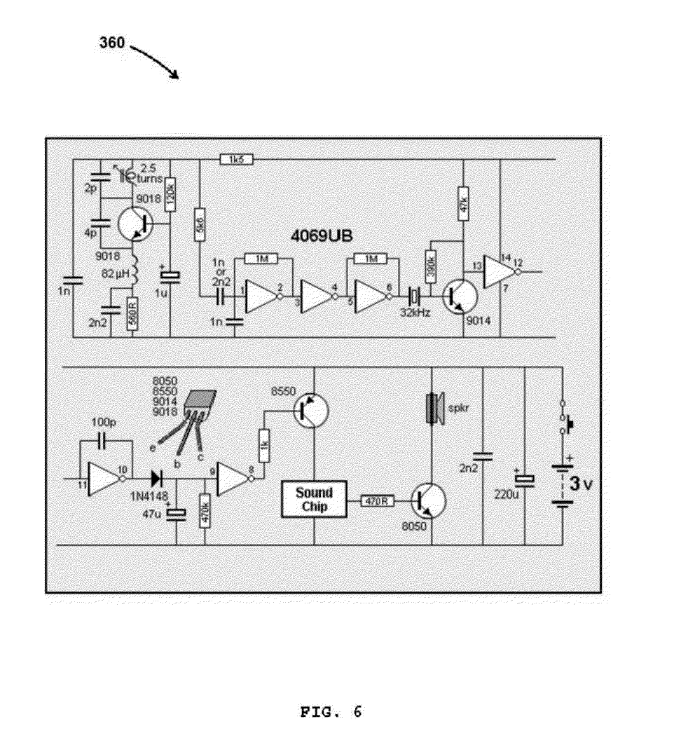

Regarding door chime unit 40, FIG. 6 illustrates an example circuit used as part of an example embodiment of doorbell chime unit 40. An example sound chip that may be used in connection therewith is a UM66 IC. Additionally, FIG. 3B discloses, in general terms, circuitry that may be used to implement doorbell chime unit 40 using existing conventional doorbell wiring 304, 306, and 314, 316.

The rest of the hardware in system 100, including wireless router 50, modem or other gateway to the Internet 60, the Internet 70, wireless phone networks 80, wireless phones 90 and other Internet-connected computing devices 75, may all be conventional systems already owned, installed, and used by a large portion of the public. Thus, for many installations of the present system the only thing that is required is a kit comprising a doorbell button unit 30 and a doorbell chime unit 40, along with any necessary software. And as described below, in certain embodiments such a kit may be retrofitted directly in place of existing, conventional doorbell buttons and chimes, without providing any new wiring or power sources.

Conventional Doorbell Wiring

A conventional doorbell is a device that emits a buzzing, ringing, chiming, or other sound to alert occupants of a structure to the presence of a visitor. Doorbells, also known as door chimes, come in two basic types, wired and battery-powered. Wired doorbell systems have existed for over a century and are by far the most common type of doorbell found in residences, commercial buildings and other structures, because they last for decades with no batteries to replace. These conventional doorbell systems are typically wired into the electrical system, ceiling, and interior and exterior walls of a building when it is originally constructed.

In most wired systems, the doorbell makes a sound via a switch that is located inside the doorbell button unit, which is typically located beside an entry door. For example, a single-button circuit 300-1 used in conventional doorbell systems is shown in FIG. 3A. The building's high voltage AC current 302 (e.g., 110 or 120 volts) is typically provided by two wires 304, 306 (hot and neutral) running from a circuit breaker (not shown) to a transformer 310, which lowers the voltage, for instance to 3 to 24 volts AC, with 16 volts AC being the most common. The transformer 310 is typically contained within the structure of the chiming unit 308, though in older installations the transformer 310 may be located external to the chiming unit 308. The low-voltage side of the transformer 310 is in electrical communication with two low-voltage wires, 314, 316. A first low-voltage wire 314 is connected with the bell or other sound-producing device 312. The low-voltage wires 314, 316 then extend from the chiming unit 308, which is typically located centrally in the home or other structure, through ceilings, interior walls, and exterior walls, until reaching the doorbell button unit 318, which comprises a doorbell button 320 that when pushed activates the sound producing device 312.

Thus, while standard high-voltage house wiring 304, 306 runs to the transformer 310, the low voltage doorbell wiring 314, 316 that runs through the building to the doorbell button unit 318 is typically thin wire, such as 18 gauge, which can only tolerate low voltage and low power. Except where otherwise specified, as used herein the term “low voltage wiring” means wiring not rated for use with more than 48 volts AC. Further, conventional doorbell wiring systems 300-1 do not provide a continuous, uninterrupted flow of electricity through the circuit, because pushing the button 320 either closes a normally open circuit or opens a normally closed circuit. Some conventional doorbell wiring systems 300-1 provide a very small amount of electrical energy substantially continuously to light a button light (not shown), but this flow of electricity is considered negligible and is not suited to powering electronics. Accordingly, the electricity available at conventional doorbell button units is not suitable for powering modern electronics, because it is both low voltage AC and not continuous.

The Present Systems May Re-Purpose Existing Conventional Doorbell Wiring

As illustrated in the example embodiment shown in FIG. 3B, in certain embodiments present systems 300-2 may be retrofitted directly in place of existing, conventional doorbell buttons 318 and chimes 308, without providing any new wiring or power sources. Example system 300-2 (which for clarity is presented as a conceptual sketch, not a literal wiring diagram) avoids the problem of intermittent power availability at the doorbell button unit 30 by providing both a wireless transmitter circuit 335 and a wireless receiver circuit 360 (described in more detail in FIGS. 5 and 6, respectively) in parallel with the doorbell button unit electronics 330. The input to the chime unit 40 connects with the same two high voltage wires 304, 306 as most conventional doorbell chimes 308. And the output from the chime unit 40 connects with the same low voltage wires 314, 316 that run through the building walls, etc., where they connect to and power the doorbell button unit 30. The doorbell button unit 30 comprises various electronics 330 that require continuous uninterrupted power; essentially all the electronics other than the wireless transmitter 335 (an example of which is described in more detail in FIG. 5) and antenna 340. When the doorbell button unit 30 is activated, for instance by pushing button 320, wireless transmitter 335 is activated and a signal is wirelessly transmitted from antenna 340 to antenna 350, which is attached with wireless receiver 360 (an example of which is described in more detail in FIG. 6). When wireless receiver 360 receives the wireless signal from the wireless transmitter 335, the wireless receiver 360 activates the sound-producing device 312. At roughly the same time, and in some cases simultaneously, a signal is transmitted from antenna 340 to wireless router 50, initiating the communication with end user 95 as described herein with respect to FIGS. 1 and 2.

Thus, in the system shown in FIG. 3B, the low voltage wires 314, 316 are repurposed from, on one hand, electrically communicating a conventional doorbell signal from a conventional doorbell button unit 318 to a conventional chime unit 308, to, on the other hand, providing uninterrupted power to wireless doorbell unit 30, which communicates the doorbell signal to the chime unit 40 wirelessly (and also communicates lots of other information via the Internet through a local WiFi connection, as described). Accordingly, for users 95 who have a WiFi network 50, 60 in their home or business 20 that is connected to the Internet 70, certain embodiments of the present system 100, 300-2, can be quickly and easily installed in place of conventional doorbell systems 300-1 simply by replacing the conventional doorbell unit 318 and chime unit 308 with the present doorbell unit 30 and chime unit 40, without requiring additional or different power sources or wiring, or special tools or skills.

Methods of Use: Installing Systems Using Existing, Conventional Doorbell Wiring

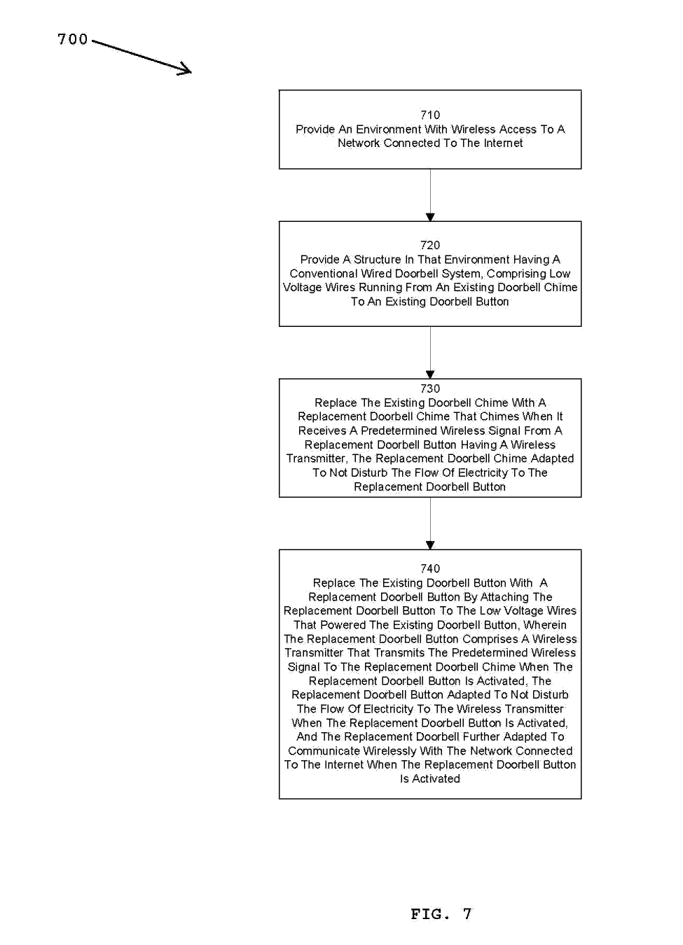

Turning to FIG. 7, provided is a method of use 700, which may comprise: 710 providing an environment with wireless access to a network 50, 60 connected to the Internet 70; 720 providing a structure 20 in that environment having a conventional wired doorbell system, comprising low voltage wires 314, 316 running from an existing doorbell chime 308 to an existing doorbell button unit 318; 730 replacing the existing doorbell chime 308 with a replacement doorbell chime 40 that chimes when it receives a predetermined wireless signal from a replacement doorbell button unit 30 having a wireless transmitter 335, 340, the replacement doorbell chime 40 adapted to not disrupt the flow of electricity to the replacement doorbell button unit 30; 740 replacing the existing doorbell button unit 318 with a replacement doorbell button unit 30 by attaching the replacement doorbell button unit 30 to the low voltage wires 314, 316 that powered the existing doorbell button unit 318, wherein the replacement doorbell button unit 30 comprises a wireless transmitter 335, 340 that transmits the predetermined wireless signal to the replacement doorbell chime unit 40 when the replacement doorbell button unit 30 is activated, the replacement doorbell button unit 30 adapted to not disrupt the flow of electricity to the wireless transmitter 335, 340 when the replacement doorbell button unit 30 is activated, and the replacement doorbell button unit 30 further adapted to communicate wirelessly with the network 50, 60 connected to the Internet 70 when the replacement doorbell button unit 30 is activated.

Methods of Use: Using Systems Once Installed

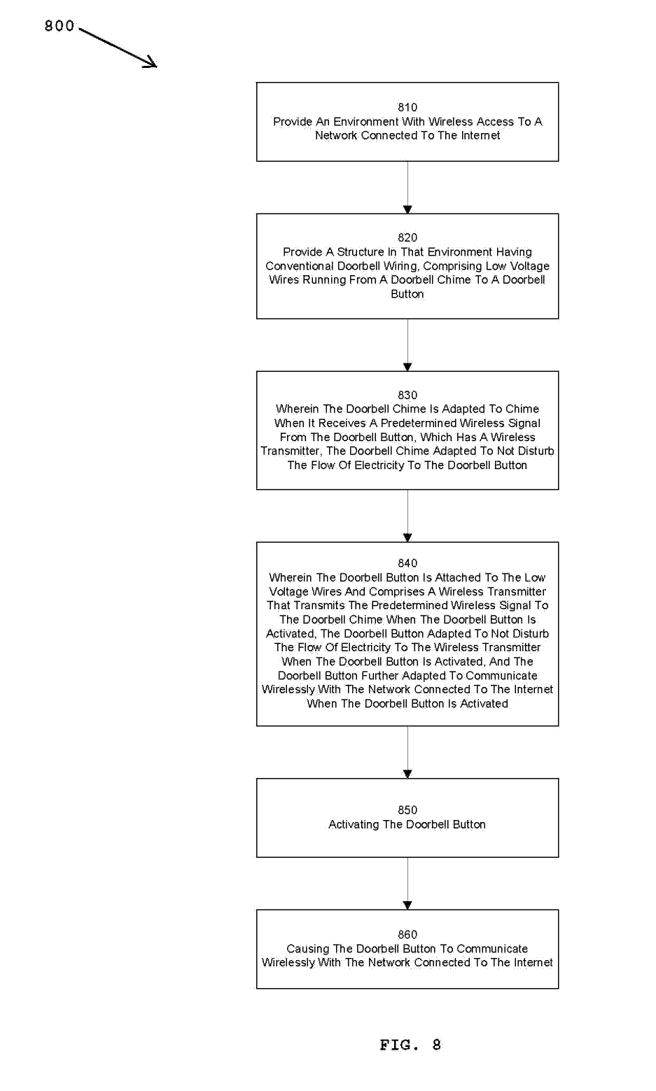

Regarding FIG. 8, provided is a method of use 800, which may comprise: 810 providing an environment with wireless access to a network 50, 60 connected to the Internet 70; 820 providing a structure 20 in that environment having conventional doorbell wiring, comprising low voltage wires 314, 316 running from a doorbell chime unit 40 to a doorbell button unit 30; 830 wherein the doorbell chime unit 40 is adapted to chime when it receives a predetermined wireless signal from the doorbell button unit 30, which has a wireless transmitter 335, 340, the doorbell chime unit 40 adapted to not disrupt the flow of electricity to the doorbell button unit 30; 840 wherein the doorbell button unit 30 is attached to and powered by the low voltage wires 314, 316 and comprises a wireless transmitter 335, 340 that transmits the predetermined wireless signal to the doorbell chime unit 40 when the doorbell button unit 30 is activated, the doorbell button unit 30 adapted to not disrupt the flow of electricity to the wireless transmitter 335, 340 when the doorbell button unit 30 is activated, and the doorbell button unit 30 further adapted to communicate wirelessly with the network 50, 60 connected to the Internet 70 when the doorbell button unit 30 is activated; 850 activating the doorbell button unit 30; 860 causing the doorbell button unit 30 to communicate wirelessly with the network 50, 60 connected to the Internet 70. Method of use 800 may further comprise any other suitable steps, such as, for example, causing the doorbell button unit 30 to communicate wirelessly with an end user 95, for instance by any or all of: sending an SMS or MMS message or an email or other electronic message or audio or video file or streaming audio or video, to a mobile device 90 or other Internet-connected computer device 75. Method of use 800 may additionally comprise causing the doorbell button unit 30 to communicate wirelessly with an end user 95 by any or all of: establishing one-way or two-way audio and/or video communications with a first person 10 located at the doorbell button unit 30. Many other steps are necessarily and inherently disclosed herein as the natural applications of the features taught and suggested herein, as would be apparent to a person of skill in the art.

Any of the suitable technologies set forth and incorporated herein may be used to implement various example aspects of the invention as would be apparent to one of skill in the art. Although exemplary embodiments and applications of the invention have been described herein including as described above and shown in the included example Figures, there is no intention that the invention be limited to these exemplary embodiments and applications or to the manner in which the exemplary embodiments and applications operate or are described herein. Indeed, many variations and modifications to the exemplary embodiments are possible as would be apparent to a person of ordinary skill in the art. The invention may include any device, structure, method, or functionality, as long as the resulting device, system or method falls within the scope of a claim allowed by the patent office.

What is claimed is:

1. A doorbell system, comprising:
a doorbell button unit; and
a doorbell chime unit;
wherein the doorbell chime unit comprises a wireless receiver adapted to trigger a notification when the wireless receiver receives a signal from the doorbell chime unit indicating that the doorbell button unit has been activated, the doorbell chime unit further adapted to provide low voltage power to the doorbell button unit suitable for transmission through low voltage wiring, the chime unit further adapted to not disrupt the flow of electricity to the doorbell button unit during use; and
wherein the doorbell button unit comprises a wireless transmitter adapted to send a signal to the wireless receiver of the doorbell chime unit when the doorbell button unit is activated, the doorbell button unit further adapted to communicate wirelessly with a network connected to the Internet when the doorbell button unit is activated, the doorbell button unit further adapted to be powered by the low voltage power provided by the doorbell chime unit, the doorbell button unit further adapted to not disrupt the flow of electricity to the wireless transmitter when the doorbell button unit is activated.

2. The doorbell system of claim 1, wherein the doorbell button unit is further adapted to cause at least one of an SMS, MMS, email message, or telephone call to be sent through a cellular telephone network to a wireless mobile device when the doorbell button unit is activated.

3. The doorbell system of claim 2, wherein the SMS, MMS, email message, or telephone call comprises at least one of audio, video, text, or image content caused to be provided by the doorbell button unit.

4. The doorbell system of claim 2, wherein the SMS, MMS, or email message comprises a link to a live streaming communication portal between the doorbell button unit and the wireless mobile device.

5. The doorbell system of claim 4, wherein the live streaming communication portal is adapted to transmit to the wireless mobile device at least one of audio, video, text, or images originating from the doorbell button unit.

6. The doorbell system of claim 5, wherein the live streaming communication portal is adapted to transmit to the doorbell button unit at least one of audio, video, text, or images originating from the wireless mobile device.

7. The doorbell system of claim 1, wherein the doorbell button unit is further adapted to cause an electronic communication to be sent through the Internet to an electronic device in communication with the Internet when the doorbell button unit is activated.

8. The doorbell system of claim 7, wherein the electronic communication comprises at least one of audio, video, text, or image content caused to be provided by the doorbell button unit.

9. The doorbell system of claim 7, wherein the electronic communication comprises a link to a live streaming communication portal between the doorbell button unit and the electronic device in communication with the Internet.

10. The doorbell system of claim 9, wherein the live streaming communication portal is adapted to transmit to the electronic device in communication with the Internet at least one of audio, video, text, or images originating from the doorbell button unit.

11. The doorbell system of claim 10, wherein the live streaming communication portal is adapted to transmit to the doorbell button unit at least one of audio, video, text, or images originating from the electronic device in communication with the Internet.

12. The doorbell system of claim 1, wherein the doorbell button unit is adapted to be activated by sensing at least one of the following: force applied to a button connected with the doorbell button unit; movement of an object in the proximity of the doorbell button unit; the presence of something near the doorbell button unit; sound; biometric information; the passage of a predetermined amount of time; an activation signal sent wirelessly from a remote user to the doorbell button unit.

13. The doorbell system of claim 1, further comprising an infrared lighting system adapted for use in low-light conditions.

14. The doorbell system of claim 1, further comprising a camera having at least one of pan, tilt, or zoom functionality that is wirelessly controllable through the Internet by a remotely located user.

15. A method comprising the steps of:
providing an environment with wireless access to a network connected to the Internet;
providing a structure in that environment having a conventional wired doorbell system, comprising low voltage wiring running from an existing doorbell chime unit to an existing doorbell button unit;
replacing the existing doorbell chime unit with a replacement doorbell chime unit that chimes when it receives a predetermined wireless signal from a replacement doorbell button unit having a wireless transmitter, the replacement doorbell chime unit adapted to not disrupt the flow of electricity to the replacement doorbell button unit during use; and
replacing the existing doorbell button unit with a replacement doorbell button unit by attaching the replacement doorbell button unit to the low voltage wires that powered the existing doorbell button unit, wherein the replacement doorbell button unit comprises a wireless transmitter that transmits the predetermined wireless signal to the replacement doorbell chime unit when the replacement doorbell button unit is activated, the replacement doorbell button unit adapted to not disrupt the flow of electricity to the wireless transmitter when the replacement doorbell button unit is activated, and the replacement doorbell button unit further adapted to communicate wirelessly with the network connected to the Internet when the replacement doorbell button unit is activated.

16. The method of claim 15, further comprising the step of: activating the replacement doorbell button unit.

17. The method of claim 15, further comprising the step of: receiving through the Internet a communication from the replacement doorbell button unit indicating that it has been activated.

18. A method comprising the steps of:
providing an environment with wireless access to a network connected to the Internet;
providing a structure in that environment having conventional doorbell wiring, comprising low voltage wires running from a doorbell chime unit to a doorbell button unit;
wherein the doorbell chime unit is adapted to chime when it receives a predetermined wireless signal from the doorbell button unit, which has a wireless transmitter, the doorbell chime unit adapted to not disrupt the flow of electricity to the doorbell button unit;
wherein the doorbell button unit is attached to and powered by the low voltage wires and comprises a wireless transmitter that transmits the predetermined wireless signal to the doorbell chime unit when the doorbell button unit is activated, the doorbell button unit adapted to not disrupt the flow of electricity to the wireless transmitter when the doorbell button unit is activated, and the doorbell button unit further adapted to communicate wirelessly with the network connected to the Internet when the doorbell button unit is activated;
activating the doorbell button unit; and
causing the doorbell button unit to communicate wirelessly with the network connected to the Internet.

19. The method of claim 18, further comprising the step of: causing the doorbell button unit to communicate wirelessly with an end user located remotely from the doorbell button unit by causing the doorbell button unit to do at least one of the following: send an SMS message, MMS message, email, telephone call, or other electronic message to a wireless mobile device.

20. The method of claim 18, further comprising the step of: causing the doorbell button unit to communicate wirelessly with an end user located remotely from the doorbell button unit by establishing a live communication channel through the Internet between a first person located at the doorbell button unit and the remotely located end user.
